(19) United States
(12) Patent Application Publication
(10) Pub. No.: US 2008/0013900 A1
(43) Pub. Date: Jan. 17, 2008

(54) FIBER BUNDLE FOR CONTACT ENDOMICROSCOPY

(75) Inventor: Martin Harris, Windsor (AU)

Correspondence Address: KNOBBE MARTENS OLSON & BEAR LLP, 2040 MAIN STREET, FOURTEENTH FLOOR, IRVINE, CA, 92614, US

(73) Assignee: Optiscan Pty Ltd., Notting Hill (AU)

(21) Appl. No.: 11/779,798

(22) Filed: Jul. 18, 2007

Related U.S. Application Data
(63) Continuation of application No. PCT/AU2005/001954, filed on Dec. 23, 2005.

(30) Foreign Application Priority Data
Jan. 21, 2005 (AU) 2005900254

(51) Int. Cl. G02B 6/06

(52) U.S. Cl. 385/117

(57) ABSTRACT

A fiber optic bundle for use in contact endoscopy or microscopy, comprising a pointed forward tip for insertion into a specimen, the forward tip having at least a portion that is oriented obliquely to the longitudinal axis of the bundle . The forward tip may be, for example, flat and oblique.

### CROSS-REFERENCE TO RELATED APPLICATIONS

This application is a continuation of PCT Patent Application No. PCT/AU2005/001954 filed on Dec. 23, 2005 which claims the benefit of the filing date of Australian Patent Application No. 2005900254 filed Jan. 21, 2005, the disclosures of which are incorporated herein by reference in their entirety.

### BACKGROUND OF THE INVENTION

1. Field of the Invention

The present invention relates to a fiber bundle for contact microscopy or endomicroscopy.

2. Description of the Related Art

Existing confocal endomicroscopes depend on the contact of a viewing window with the tissue to stabilize the tissue under observation and minimize motion artifacts and to provide a smooth optical interface during the acquisition of images.

One variation of bundle microscopy used by Mauna Kea Technologies (a French company) is to eliminate the window and the lens and to make the tip of the bundle directly touch the tissue to be imaged. This principle was first described by Kapany in 1965 for in vivo reflection images of microvasculature with broad-field illumination carried by the same fiber.

Hirano, Yamashita, and Miyakawa (in Brain Research, April 1996) report visualizing hippocampal cells in vivo during anoxia by means of a fiber-optic plate microscope system comparable to that Kapany's system but with an angle polished tip and using fluorescence. U.S. Pat. No. 3,556,085 (Nagashige Takahashi) discloses an angle polished tip bundle, but in Takahashi's system illumination is transmitted to the observational field by a separate bundle of fibers and his system includes a relay lens train within the bundle.

The application of fluorescence and the greater discrimination and sensitivity of confocal systems has greatly extended its range. The x-y resolution in this imaging mode is determined by the inter-core spacing at the contact face, following standard information theory.

Available core/cladding glass combinations can achieve numerical apertures (NAs) of 0.4-0.5, which defines a resolution limit of 4-5 micron. Useful images, however, can be obtained with bundles of 300 microns diameter containing fewer than 10,000 fibers.

### SUMMARY OF THE INVENTION

According to a first broad aspect, the invention provides a fiber optic bundle for use in contact endoscopy or microscopy, comprising:
a pointed forward tip for insertion into a specimen, having at least a portion that is oriented obliquely to the longitudinal axis of the bundle.

The forward tip may be formed flat but oblique, conically, or otherwise, to facilitate passage through a specimen or other sample and/or contact with the specimen.

Thus, the bundle can be used like a needle, to facilitate insertion of the bundle into, for example, tissue. The forward tip may be polished.

In one embodiment, the forward tip is at an angle to the longitudinal axis and hence to the propagation direction of incoming excitation light such that the excitation light is not totally internally reflected at an interface defined by the forward tip and the specimen back into the fiber optic bundle.

The fluorescence of fiber polymer coatings and tip potting materials eliminate current “soft-wound” bundles from this application, but as the bundle is often pushed into tissue like a hypodermic syringe, the stiffness provided by the fused bundle may be a desirable feature.

Angle polishing the tip is very easy to do and facilitates its penetration into tissue.

In certain embodiments, the forward tip is at an angle to the longitudinal axis and hence to a propagation direction of incoming excitation light such that said excitation light is totally internally reflected at an interface defined by the forward tip and the specimen back into the fiber optic bundle. This allows evanescent wave fluorescence microscopy, as incident light directed towards the specimen is totally internally reflected back into the bundle. Fluorescent molecules in close proximity to the tip (less than 1 micron from the surface) are influenced and excited by the evanescent EM field. Fluorescence at such distances is also coupled back into the cores. Hence a confocal evanescent contact mode of microscopy is possible for angles more acute than the critical angle.

It is envisaged that this approach would provide sub-micron z resolution.

Fat droplets or other structures of higher refractive index (RI) within the specimen could also be imaged, such as by coupling the light out from the core. Various detection methods for this light could be envisaged including detection via adjacent fibers.

Alternatively, the forward tip may be concave or convex so that one part of the forward tip is operating within a critical angle for total internal reflection at an interface defined by the forward tip and the specimen, and another part of the forward tip is not operating within the critical angle. This typically produces two regions of non-critical angle contact at the tip/specimen interface, separated by a boundary critical angle contact (and hence maximum sensitivity for evanescent wave fluorescence microscopy or the like). That boundary may differ according to the refractive index of the specimen, with two benefits: a greater range of specimen refractive indices are accommodated, and useful information may be ascertainable from the form and location of the boundary.

It should be noted that the z resolution for flat-ended fiber bundle contact microscopy is quoted by Mauna Kea Technologies as 15 microns. This figure would appear to be defined by the distances on the tissue side of the bundle tip plane, so it is not directly comparable with the normal ratio between x-y resolution and optical sectioning ability. In fact it appears to be half this value, which is to be expected for the NA of the bundle being used.

The anamorphic distortion/aspect ratio introduced by the elliptical profile of the oblique tip should not be too extreme but images may require interpretation. Making images isomorphic using scan ratio changes or by means of software adjustment is relatively easy but may not be necessary, or in fact best for interpretation.

The bundle may further comprise an optical coupler for coupling return light out from one or more fiber cores of the fiber optic bundle.

In one embodiment, the forward tip has a roughened finish.

The bundle may further comprise a periodic structure of lines or discrete regions provided on the forward tip.

The bundle may further comprise a thin layer of a biologically compatible metal provided on the forward tip, as a thin uniform layer, as thin lines or strips, or as discrete uniform structures

The forward tip may comprise a Bragg grating reflector for light in the fiber optic bundle, such as formed of the aforementioned periodic structures or thin layer of a biologically compatible metal.

According to a second aspect, the invention provides a method of performing contact endoscopy, comprising introducing a fiber optic bundle with a pointed leading tip into a specimen.

The method may further comprise providing the leading tip as a flat and oblique leading tip. Alternatively, the leading tip may be provided as a conical leading tip.

The method may further comprise providing the leading tip at an angle to a propagation direction of incoming excitation light to totally internally reflect the excitation light at an interface defined by the leading tip and the specimen back into the fiber optic bundle.

Alternatively the method may further comprise providing the leading tip at an angle to a propagation direction of incoming excitation light to avoid totally internally reflecting the excitation light at an interface defined by the leading tip and the specimen back into the fiber optic bundle.

According to this aspect, the leading tip may be polished. Also, the method may include roughening the leading tip (whether after previous polishing or otherwise).

The method may further comprise obtaining return light from those optic fibers in the fiber optic bundle with respective forward tips distal to an exit core tip of an excitation light optic fiber.

The method may further comprise introducing a hypodermic syringe (or equivalent structure) into the specimen and passing the fiber optic bundle down the hypodermic syringe, in order to facilitate correctly locating the leading tip at a desired location in the specimen.

According to a third aspect, the invention provides a method of performing contact endoscopy or microscopy, comprising placing a fiber optic bundle with a pointed leading tip against a specimen.

According to a fourth aspect, the invention provides an endoscope or microscope for use in contact endoscopy or microscopy, comprising: a fiber optic bundle having a pointed forward tip for inserting into or placing against a specimen, the forward tip having at least a portion that is oriented obliquely to the longitudinal axis of the bundle. The fiber optic bundle of this aspect may have any of the features of the fiber optic bundle of the first aspect of the invention described above.

### BRIEF DESCRIPTION OF THE DRAWING

In order that the invention may be more clearly ascertained, embodiments will now be described, by way of example, with reference to the accompanying drawing, in which:

FIG. 1 is an isomorphic view of an angle polished fiber bundle tip according to an embodiment of the invention;

FIG. 2 is a cross sectional view of the angle polished tip bundle of FIG. 1;

FIG. 3 is a view of a fiber bundle with a conical tip according to another embodiment of the invention;

FIG. 4 is a view of an endoscopic system according to another embodiment of the invention being used to test meat; and

FIGS. 5A and 5B are views of further embodiments of respective angle polished fiber bundle tips according to the invention with, respectively, concave and convex forward tips.

### DETAILED DESCRIPTION OF THE INVENTION

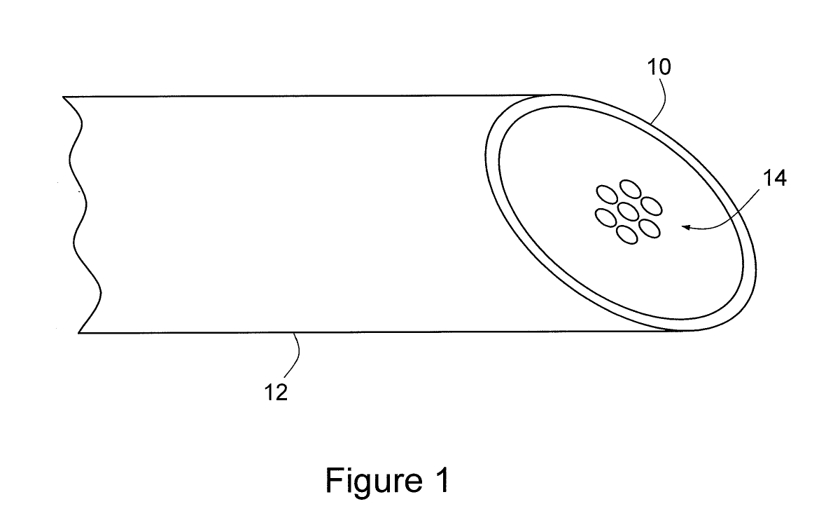

FIG. 1 is an isomorphic view of an angle polished fiber bundle tip 10 of a bundle 12 according to an embodiment of the invention, showing the cores 14 of the constituent fibers. The tip 10 is essentially in the form of a planar ellipse.

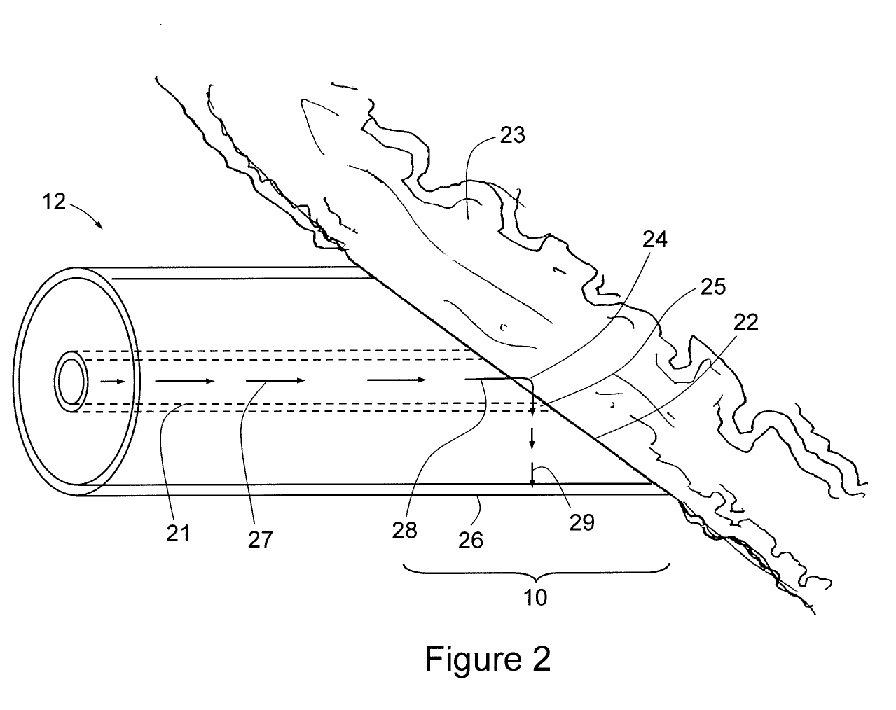

FIG. 2 is a cross sectional view of the forward end of the bundle 12 with its angle-polished tip 10. Light, represented by arrows 27, 28, 29, travels along one of the cores 14 (in this example, representative fiber core 21) and reaches the interface 22 between the angle-polished bundle tip 10 and a specimen in the form of tissue 23. At angles close to the critical angle for total internal refection (TIR), the EM energy penetrates a substantial distance 24 into the lower RI material of the tissue before it returns into the glass 25 and traverses across the bundle to be absorbed by the black glass outer layer 26.

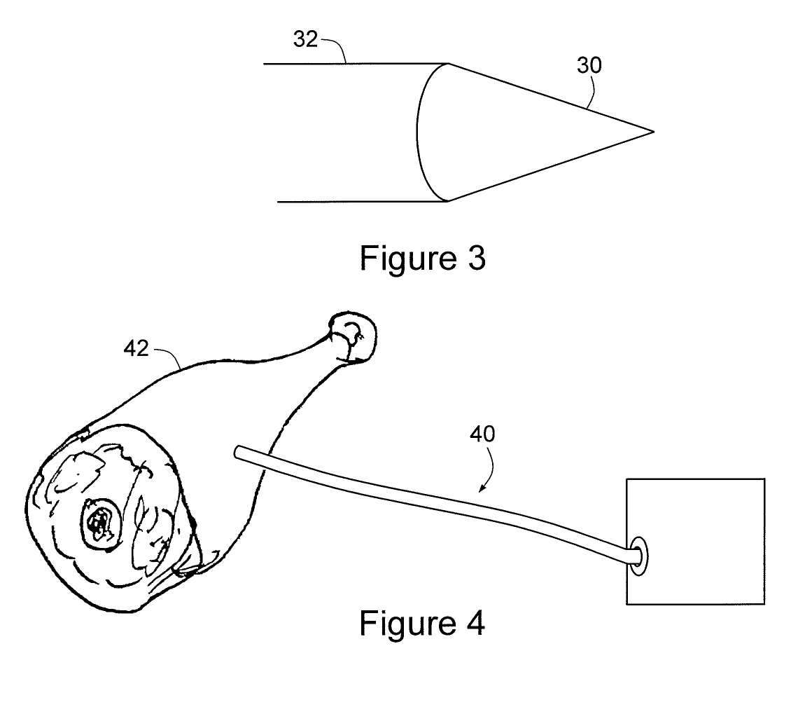

FIG. 3 is a view of a conical tip 30 of a fiber bundle 32 according to another embodiment of the invention, operating on the same principle.

FIG. 4 is a view of an endoscopic system 40 according to another embodiment of the invention being used to test a sample of meat 42.

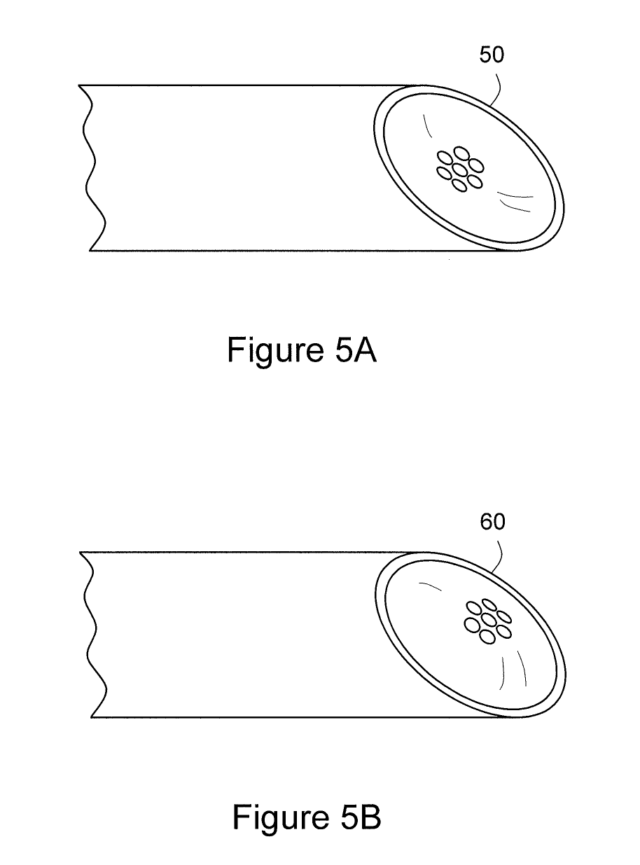

FIGS. 5A and 5B are isomorphic views of further embodiments of respective angle polished fiber bundle tips 50 and 60 according to the invention. These fiber bundle tips 50 and 60 are similar to the tip 10 of FIG. 1, except that the tip 50 of FIG. 5A is concave and the tip 60 of FIG. 5B is convex. This means that one part of the forward tip in each case is operating within a critical angle for total internal reflection at the interface between the forward tip and a specimen, and another part of the forward tip is not operating within the critical angle.

The concavity of fiber bundle tip 50 and convexity of fiber bundle tip 60 are ellipsoid, but could be of other forms (including cylindrical or paraboloidal). Further, the degree of concavity or convexity may be selected according to intended application. For example, it may be desirable to employ a higher degree of concavity or convexity with a specimen that has a greater range of refractive indices.

Modifications within the scope of the invention may be readily effected by those skilled in the art. It is to be understood, therefore, that this invention is not limited to the particular embodiments described by way of example hereinabove.

Further, any reference herein to prior art is not intended to imply that such prior art forms or formed a part of the common general knowledge.

What is claimed is:

1. A device for use in contact endoscopy or microscopy, comprising:
a fiber optic bundle; and
a pointed forward tip configured for insertion into a specimen, said forward tip having at least a portion that is oriented obliquely to a longitudinal axis of said fiber optic bundle.

2. The device as claimed in claim 1, wherein said forward tip is flat and oblique.

3. The device as claimed in claim 1, wherein said forward tip is conical.

4. The device as claimed in claim 1, wherein said forward tip is at an angle to said longitudinal axis and to a propagation direction of incoming excitation light such that said excitation light is totally internally reflected at an interface defined by said forward tip and said specimen back into said fiber optic bundle.

5. The device as claimed in claim 1, wherein said forward tip is at an angle to said longitudinal axis and hence to a propagation direction of incoming excitation light such that said excitation light is not totally internally reflected at an interface defined by said forward tip and said specimen back into said fiber optic bundle.

6. The device as claimed in claim 1, wherein said forward tip is concave or convex so that one part of said forward tip is operating within a critical angle for total internal reflection at an interface defined by said forward tip and said specimen, and another part of said forward tip is not operating within said critical angle.

7. The device as claimed in claim 1, wherein said forward tip is polished.

8. The device as claimed in claim 1, further comprising an optical coupler for coupling return light out from one or more fiber cores of said fiber optic bundle.

9. The device as claimed in claim 1, wherein said forward tip has a roughened finish.

10. The device as claimed in claim 1, further comprising a periodic structure of lines or discrete regions provided on said forward tip.

11. The device as claimed in claim 1, further comprising a thin layer of a biologically compatible metal provided on said forward tip, as a thin uniform layer, as thin lines or strips, or as discrete uniform structures.

12. The device as claimed in claim 1, wherein said forward tip comprises a Bragg grating reflector for light in said fiber optic bundle.

13. A method of performing contact endoscopy, comprising introducing into a specimen a fiber optic bundle with a pointed leading tip.

14. The method as claimed in claim 13, further comprising providing said leading tip as a flat and oblique leading tip.

15. The method as claimed in claim 13, further comprising providing said leading tip as a conical leading tip.

16. The method as claimed in claim 13, further comprising providing said leading tip at an angle to a propagation direction of incoming excitation light to totally internally reflect said excitation light at an interface defined by said leading tip and said specimen back into said fiber optic bundle.

17. The method as claimed in claim 13, further comprising providing said leading tip at an angle to a propagation direction of incoming excitation light to avoid totally internally reflecting said excitation light at an interface defined by said leading tip and said specimen back into said fiber optic bundle.

18. The method as claimed in claim 13, wherein said leading tip is polished.

19. The method as claimed in claim 13, including roughening said leading tip.

20. The method as claimed in claim 13, further comprising obtaining return light from those optic fibers in said fiber optic bundle with respective forward tips distal to an exit core tip of an excitation light optic fiber.

21. The method as claimed in claim 13, further comprising introducing a hypodermic syringe into said specimen and passing said fiber optic bundle down said hypodermic syringe.

22. A method of performing contact endoscopy or microscopy, comprising placing a fiber optic bundle with a pointed leading tip against a specimen.

23. The method as claimed in claim 22, wherein said leading tip is flat and oblique.

24. An endoscope or microscope for use in contact endoscopy or microscopy, comprising:
a fiber optic bundle comprising a pointed forward tip for inserting into or placing against a specimen, said forward tip having at least a portion that is oriented obliquely to the longitudinal axis of said fiber optic bundle.
